(19) United States
(12) Patent Application Publication
(10) Pub. No.: US 2013/0117200 A1
(43) Pub. Date: May 9, 2013

(54) SYSTEMS AND METHODS FOR OPTIMIZATION OF INVESTMENT PORTFOLIOS

(71) Applicant: D-Wave Systems Inc., Burnaby (CA)

(72) Inventor: Murray C. Thom, Vancouver (CA)

(73) Assignee: D-WAVE SYSTEMS INC., Burnaby (CA)

(21) Appl. No.: 13/673,578

(22) Filed: Nov. 9, 2012

Related U.S. Application Data
(60) Provisional application No. 61/557,846, filed on Nov. 9, 2011.

(51) Int. Cl. G06Q 40/06; G06N 99/00

(52) U.S. Cl. CPC G06Q 40/06; G06N 99/002
USPC 705/36 R

(57) ABSTRACT

Systems and methods for operating digital computer system and a quantum processor to optimize an investment portfolio are described. A set of candidate investments is mapped to the qubits of the quantum processor, where each qubit is programmed with a respective programmable qubit parameter that is representative of the recent performance of the particular candidate investment to which the qubit corresponds. Pair-wise correlations between the candidate investments are mapped to coupling devices of the quantum processor, where each coupling device is programmed with a respective programmable coupling parameter that is representative of the particular correlation to which the coupling device corresponds. The quantum processor is evolved to determine the minimum energy configuration of the qubit states with respect to the programmable qubit and coupling device parameters. The digital computer system interacts with the quantum processor via an investment portfolio optimization module.

### BACKGROUND

### Field

The present systems and methods generally relate to operating a quantum processor to optimize a portfolio of investments.

### Adiabatic Quantum Computation

Adiabatic quantum computation typically involves evolving a system from a known initial Hamiltonian (the Hamiltonian being an operator whose eigenvalues are the allowed energies of the system) to a final Hamiltonian by gradually changing the Hamiltonian. A simple example of an adiabatic evolution is given by:

Hₑ=(1−s)Hᵢ+sH_{f}

where Hᵢ is the initial Hamiltonian, H_{f} is the final Hamiltonian, Hₑ is the evolution or instantaneous Hamiltonian, and s is an evolution coefficient which controls the rate of evolution. As the system evolves, the evolution coefficient s goes from 0 to 1 such that at the beginning (i.e., s=0) the evolution Hamiltonian Hₑ is equal to the initial Hamiltonian Hᵢ and at the end (i.e., s=1) the evolution Hamiltonian Hₑ is equal to the final Hamiltonian H_{f}. Before the evolution begins, the system is typically initialized in a ground state of the initial Hamiltonian Hᵢ and the goal is to evolve the system in such a way that the system ends up in a ground state of the final Hamiltonian H_{f} at the end of the evolution. If the evolution is too fast, then the system can be excited to a higher energy state, such as the first excited state. In the present systems and methods, an “adiabatic” evolution is considered to be an evolution that satisfies the adiabatic condition:

\dot{s}| [symbol] 1|dHₑ/dS|0 [symbol] |=δg²(s)

where \dot{s} is the time derivative of s, g(s) is the difference in energy between the ground state and first excited state of the system (also referred to herein as the “gap size”) as a function of s, and δ is a coefficient much less than 1.

The evolution process in adiabatic quantum computing may sometimes be referred to as annealing. The rate that s changes, sometimes referred to as an evolution or annealing schedule, is normally slow enough that the system is always in the instantaneous ground state of the evolution Hamiltonian during the evolution, and transitions at anti-crossings (i.e., when the gap size is smallest) are avoided. Further details on adiabatic quantum computing systems, methods, and apparatus are described in, for example, U.S. Pat. No. 7,135,701 and U.S. Pat. No. 7,418,283.

### Quantum Annealing

Quantum annealing is a computation method that may be used to find a low-energy state, typically preferably the ground state, of a system. Somewhat similar in concept to classical annealing, the method relies on the underlying principle that natural systems tend towards lower energy states because lower energy states are more stable. However, while classical annealing uses classical thermal fluctuations to guide a system to its global energy minimum, quantum annealing may use quantum effects, such as quantum tunneling, to reach a global energy minimum more accurately and/or more quickly than classical annealing. It is known that the solution to a hard problem, such as a combinatorial optimization problem, may be encoded in the ground state of a system Hamiltonian (e.g., the Hamiltonian of an (sing spin glass) and therefore quantum annealing may be used to find the solution to such a hard problem. Adiabatic quantum computation may be considered a special case of quantum annealing for which the system, ideally, begins and remains in its ground state throughout an adiabatic evolution. Thus, those of skill in the art will appreciate that quantum annealing systems and methods may generally be implemented on an adiabatic quantum computer, and vice versa. Throughout this specification and the appended claims, any reference to quantum annealing is intended to encompass adiabatic quantum computation unless the context requires otherwise.

Quantum annealing uses quantum mechanics as a source of disorder during the annealing process. The optimization problem is encoded in a Hamiltonian H_{P}, and the algorithm introduces strong quantum fluctuations by adding a disordering Hamiltonian H_{D} that does not commute with H_{P}. An example case is:

H_{E}=H_{P}+ΓH_{D},

where Γ changes from a large value to substantially zero during the evolution and H_{E} may be thought of as an evolution Hamiltonian similar to Hₑ described in the context of adiabatic quantum computation above. The disorder is slowly removed by removing H_{D} (i.e., reducing Γ). Thus, quantum annealing is similar to adiabatic quantum computation in that the system starts with an initial Hamiltonian and evolves through an evolution Hamiltonian to a final “problem” Hamiltonian H_{P} whose ground state encodes a solution to the problem. If the evolution is slow enough, the system will typically settle in the global minimum (i.e., the exact solution), or in a local minimum close to the exact solution. The performance of the computation may be assessed via the residual energy (distance from exact solution using the objective function) versus evolution time. The computation time is the time required to generate a residual energy below some acceptable threshold value. In quantum annealing, H_{P} may encode an optimization problem and therefore H_{P} may be diagonal in the subspace of the qubits that encode the solution, but the system does not necessarily stay in the ground state at all times. The energy landscape of H_{P} may be crafted so that its global minimum is the answer to the problem to be solved, and low-lying local minima are good approximations.

The gradual reduction of Γ in quantum annealing may follow a defined schedule known as an annealing schedule. Unlike traditional forms of adiabatic quantum computation where the system begins and remains in its ground state throughout the evolution, in quantum annealing the system may not remain in its ground state throughout the entire annealing schedule. As such, quantum annealing may be implemented as a heuristic technique, where low-energy states with energy near that of the ground state may provide approximate solutions to the problem.

### Quantum Processor

A quantum processor may take the form of a superconducting quantum processor. A superconducting quantum processor may include a number of qubits and associated local bias devices, for instance two or more superconducting qubits. A superconducting quantum processor may also employ coupling devices (i.e., “couplers”) providing communicative coupling between qubits. Further details and embodiments of exemplary quantum processors that may be used in conjunction with the present systems and methods are described in, for example, U.S. Pat. No. 7,533,068, U.S. Pat. No. 8,008,942, US Patent Publication 2008-0176750 (now U.S. Pat. No. 8,195,596), US Patent Publication 2009-0121215 (now U.S. Pat. No. 8,190,548), and US Patent Publication 2011-0022820.

### Investment Portfolios

Throughout this specification and the appended claims, the terms “investment portfolio” and “portfolio of investments” are used to describe any set or combination of individual investments, including but not limited to individual investments in stocks, bonds, stock indexes, equities, currencies, assets, and/or commodities. Investment portfolios are typically constructed to diversify an investment fund with a goal of increasing expected returns and/or mitigating risk. A hedge fund is an example of an investment portfolio that typically seeks to mitigate risk by selecting individual investments that are negatively correlated (i.e., anti-correlated) such that poor performance of a first investment may be offset by good performance of a second, negatively-correlated investment.

In constructing an investment portfolio, a very large number of potential investments (i.e., “candidate investments”) are available from which to choose. Accordingly, the construction of an investment portfolio, such as a hedge fund, is a very complicated and strategic endeavor where even very small improvements can provide significant gains and competitive advantage. The very large number of candidate investments available from which to choose produces such a vast number of potential portfolio configurations that classical digital computing systems (even gymnasium-sized supercomputers) are of limited utility in optimizing investment portfolios. The scope of the optimization problem is even further expanded when one considers how to allocate funds between selected investments (e.g., x % invested in investment A, y % invested in investment B, etc.). Accordingly, there remains a need in the art for improved systems and methods for optimizing investment portfolios.

### BRIEF SUMMARY

A method of operating a digital computer system and a quantum processor to optimize a portfolio of investments, wherein the quantum processor comprises a number of qubits and a number of coupling devices operable to provide communicative coupling between respective pairs of the qubits, may be summarized as including analyzing a set of candidate investments via the digital computer system to evaluate a performance of each individual candidate investment within a defined time period; analyzing the set of candidate investments via the digital computer system to evaluate a correlation between each respective pair of the candidate investments within the defined time period; mapping the candidate investments to the qubits of the quantum processor via a programming subsystem such that each candidate investment corresponds to at least one qubit in the quantum processor; programming each qubit in the quantum processor with a respective programmable qubit parameter via the programming subsystem, wherein each respective programmable qubit parameter has a sign and a magnitude that depend on the performance of the candidate investment to which the qubit corresponds; mapping the correlations between respective pairs of the candidate investments to the coupling devices of the quantum processor via the programming subsystem such that each correlation corresponds to at least one coupling device in the quantum processor; programming each coupling device in the quantum processor with a programmable coupling parameter via the programming subsystem, wherein each respective programmable coupling parameter has a sign and a magnitude that depend on the correlation to which the coupling device corresponds; and evolving the quantum processor via an evolution subsystem to determine an optimal portfolio of investments corresponding to a subset of investments from the set of candidate investments. Evolving the quantum processor via an evolution subsystem may include performing at least one of adiabatic quantum computation and quantum annealing via the quantum processor. The quantum processor may include a superconducting quantum processor comprising superconducting qubits and superconducting coupling devices. Each respective programmable qubit parameter may correspond to a respective hᵢ term in a Hamiltonian of the quantum processor and each respective programmable coupling parameter may correspond to a respective Jᵢⱼ term in a Hamiltonian of the quantum processor. The set of candidate investments may include at least one investment selected from the group consisting of: a stock, a bond, a stock index, an equity, a currency, an asset and a commodity. The defined time period may be selected from the group consisting of: a number of hours, a number of days, a number of weeks, a number of months, a number of years, and a number of decades.

Analyzing a set of candidate investments via a digital computer system to evaluate a performance of each individual candidate investment within a defined time period may include generating a first subset of the candidate investments having positive performance within the defined time period and a second subset of the candidate investments having negative performance within the defined time period via the digital computer system. Programming each qubit in the quantum processor with a respective programmable qubit parameter via the programming subsystem may include programming each qubit that corresponds to a candidate investment from the first subset of candidate investments having positive performance with a respective programmable qubit parameter having a positive magnitude via the programming subsystem. Programming each qubit in the quantum processor with a respective programmable qubit parameter via the programming subsystem may include programming each qubit that corresponds to a candidate investment from the second subset of candidate investments having negative performance with a respective programmable qubit parameter having a negative magnitude via the programming subsystem. The optimal portfolio of investments may include predominately investments from the first subset of candidate investments having positive performance. Analyzing a set of candidate investments via a digital computer system to evaluate a performance of each individual candidate investment within a defined time period may include evaluating a change in a value of each individual candidate investment within the defined time period via the digital computer system.

Analyzing the set of candidate investments via the digital computer system to evaluate a correlation between each respective pair of the candidate investments within the defined time period may include generating a first subset of correlations between pairs of the candidate investments that are positively correlated within the defined time period and a second subset of correlations between pairs of the candidate investments that are negatively correlated within the defined time period via the digital computer system. Programming each coupling device in the quantum processor with a respective programmable coupling parameter via the programming subsystem may include programming each coupling device that corresponds to a correlation from the first subset of correlations between pairs of candidate investments that are positively correlated with a respective programmable coupling parameter having a positive magnitude via the programming subsystem. Programming each coupling device in the quantum processor with a respective programmable coupling parameter via the programming subsystem may include programming each coupling device that corresponds to a correlation from the second subset of correlations between pairs of candidate investments that are negatively correlated with a respective programmable coupling parameter having a negative magnitude via the programming subsystem. The optimal portfolio of investments may include predominately pairs of investments that correspond to correlations from the second subset of correlations between pairs of candidate investments that are negatively correlated. Analyzing a set of candidate investments via a digital computer system to evaluate a correlation between each respective pair of the candidate investments within the defined time period may include evaluating a change in a value of each individual candidate investment within the defined time period via the digital computer system and comparing the respective changes in the value of each respective pair of candidate investments via the digital computer system.

The digital computer system may include a non-transitory computer-readable memory that stores an investment portfolio optimization module, and analyzing a set of candidate investments via the digital computer system to evaluate a performance of each individual candidate investment within a defined time period may include analyzing the set of candidate investments via the investment portfolio optimization module and analyzing the set of candidate investments via the digital computer system to evaluate a correlation between each respective pair of the candidate investments within the defined time period includes analyzing the set of candidate investments via the investment portfolio optimization module.

A method of operating a quantum processor to optimize a portfolio of investments, wherein the quantum processor comprises a number of qubits and a number of coupling devices operable to provide communicative coupling between respective pairs of the qubits and the portfolio of investments comprises a subset of investments from a set of candidate investments, may be summarized as including mapping the candidate investments to the qubits of the quantum processor via a programming subsystem such that each candidate investment in the set of candidate investments corresponds to at least one qubit in the quantum processor; mapping correlations between respective pairs of the candidate investments to the coupling devices of the quantum processor via the programming subsystem such that each correlation corresponds to at least one coupling device in the quantum processor; and evolving the quantum processor via an evolution subsystem to determine an optimal portfolio of investments corresponding to a subset of investments from the set of candidate investments. Evolving the quantum processor via an evolution subsystem may include performing at least one of adiabatic quantum computation and quantum annealing via the quantum processor. The quantum processor may include a superconducting quantum processor comprising superconducting qubits and superconducting coupling devices. The method may include programming each qubit in the quantum processor with a respective programmable qubit parameter via the programming subsystem, wherein each respective programmable qubit parameter has a sign and a magnitude that depend on the performance of the candidate investment to which the qubit corresponds, and wherein each respective programmable qubit parameter corresponds to a respective hᵢ term in a Hamiltonian of the quantum processor. The method may further include programming each coupling device in the quantum processor with a programmable coupling parameter via the programming subsystem, wherein each respective programmable coupling parameter has a sign and a magnitude that depend on the correlation to which the coupling device corresponds, and wherein each respective programmable coupling parameter corresponds to a respective Jᵢⱼ term in a Hamiltonian of the quantum processor. The set of candidate investments may include at least one investment selected from the group consisting of: a stock, a bond, a stock index, an equity, a currency, an asset and a commodity. The defined time period may be selected from the group consisting of: a number of hours, a number of days, a number of weeks, a number of months, a number of years, and a number of decades.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 is a schematic diagram of a portion of a superconducting quantum processor designed for adiabatic quantum computation and/or quantum annealing to implement the present systems and methods.

FIG. 2 is an illustrative graph showing exemplary changes in the value (i.e., asset price) of three assets over time in accordance with the present systems and methods

FIG. 3 is a flow-diagram showing a method of operating a quantum processor to optimize an investment portfolio in accordance with the present systems and methods.

FIG. 4 is an illustrative diagram providing a graphical representation of the analysis (e.g., performed by a computer processor) of three investments over a defined time period in accordance with the present systems and methods.

FIG. 5 is a flow-diagram showing a method of operating a digital computer system and a quantum processor to optimize an investment portfolio in accordance with the present systems and methods.

FIG. 6 illustrates an exemplary digital computer system that may be used to perform classical digital processing tasks described in the present systems and methods.

### DETAILED DESCRIPTION

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with quantum processors, such as quantum devices, coupling devices, and control systems including microprocessors and drive circuitry have not been shown or described in detail to avoid unnecessarily obscuring descriptions of the embodiments of the present systems and methods. Throughout this specification and the appended claims, the words “element” and “elements” are used to encompass, but are not limited to, all such structures, systems and devices associated with quantum processors, as well as their related programmable parameters.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” or “an embodiment,” or “another embodiment” means that a particular referent feature, structure, or characteristic described in connection with the embodiment is included in at least one embodiment. Thus, the appearances of the phrases “in one embodiment,” or “in an embodiment,” or “another embodiment” in various places throughout this specification are not necessarily all referring to the same embodiment. Furthermore, the particular features, structures, or characteristics may be combined in any suitable manner in one or more embodiments.

It should be noted that, as used in this specification and the appended claims, the singular forms “a,” “an,” and “the” include plural referents unless the content clearly dictates otherwise. Thus, for example, reference to a problem-solving system including “a quantum processor” includes a single quantum processor, or two or more quantum processors. It should also be noted that the term “or” is generally employed in its sense including “and/or” unless the content clearly dictates otherwise.

The headings provided herein are for convenience only and do not interpret the scope or meaning of the embodiments.

The various embodiments described herein provide systems and methods for optimization of investment portfolios. More specifically, the various embodiments described herein provide systems and methods for operating a quantum processor to select an optimal portfolio of investments corresponding to a subset of selected investments from a set of candidate investments by performing adiabatic quantum computation and/or quantum annealing.

Throughout this specification and the appended claims, the terms “candidate investment” and “candidate investments” are used to describe any potential investment opportunity. The optimization of an investment portfolio involves selecting a subset (e.g., an optimal subset) of investments from the complete set of all candidate investments into which to invest.

In accordance with some embodiments of the present systems and methods, a quantum processor may be designed to perform adiabatic quantum computation and/or quantum annealing. As previously discussed, a typical adiabatic evolution may be represented by equation 1:

Hₑ=(1−s)H_{In}+sH_{f} (1)

where H_{In} is the initial Hamiltonian, H_{f} is the final or “problem” Hamiltonian, Hₑ is the evolution or instantaneous Hamiltonian, and s is the evolution coefficient which controls the rate of evolution. In general, s may vary from 0 to 1 with time t as s(t). A common approach to adiabatic quantum computation (“AQC”), described, for example, in Amin, M.H.S., “Effect of local minima on quantum adiabatic optimization”, PRL 100, 130503 (2008), is to start with an initial Hamiltonian of the form shown in equation 2:

$${H}_{I n} = - \frac{1}{2} {\sum }_{i = 1}^{N} {Δ}_{i} {σ}_{i}^{x} \qquad ( 2 )$$

where N represents the number of qubits, σᵢ^{x} is the Pauli x-matrix for the i^{th} qubit and Δᵢ is the single qubit tunnel splitting induced in the i^{th} qubit. Here, the σᵢ^{x} terms are examples of “off-diagonal” terms. An initial Hamiltonian of this form may, for example, be evolved to a final Hamiltonian of the form:

$${H}_{f} = - \frac{ɛ}{2} [ {\sum }_{i = 1}^{n} {h}_{i} {σ}_{i}^{z} + {\sum }_{i , j = 1}^{N} {J}_{ij} {σ}_{i}^{z} {σ}_{j}^{z} ] \qquad ( 3 )$$

where N represents the number of qubits, σᵢ^{z} is the Pauli z-matrix for the i^{th} qubit, hᵢ and J_{i,j} are dimensionless local fields coupled into each qubit, and ε is some characteristic energy scale for H_{f}. Here, the σᵢ^{z} and σᵢ^{z}σⱼ^{z} terms are examples of “diagonal” terms. Throughout this specification, the terms “final Hamiltonian” and “problem Hamiltonian” are used interchangeably. Hamiltonians such as H_{In} and H_{f} in equations 2 and 3, respectively, may be physically realized in a variety of different ways. A particular example is realized by an implementation of superconducting qubits.

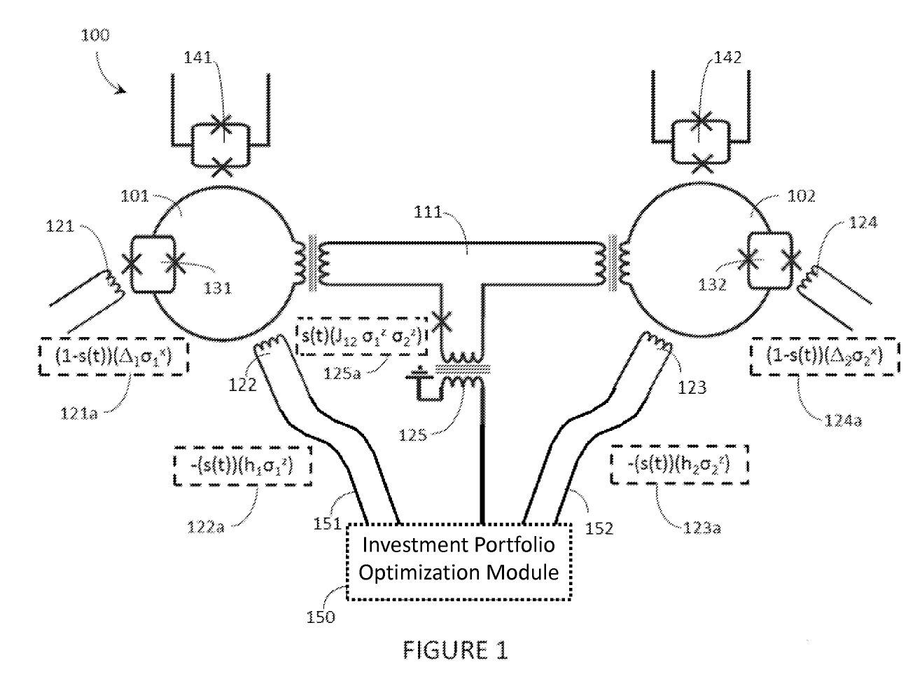

FIG. 1 is a schematic diagram of a portion of an exemplary superconducting quantum processor 100 designed for AQC (and/or quantum annealing) that may be used to implement the present systems and methods. The portion of superconducting quantum processor 100 shown in FIG. 1 includes two superconducting qubits 101, 102 and a tunable ZZ-coupler 111 coupling information therebetween (i.e., providing pair-wise coupling between qubits 101 and 102). While the portion of quantum processor 100 shown in FIG. 1 includes only two qubits 101, 102 and one coupler 111, those of skill in the art will appreciate that quantum processor 100 may include any number of qubits and any number of coupling devices coupling information therebetween.

The portion of quantum processor 100 shown in FIG. 1 may be implemented to physically realize AQC and/or QA by initializing the system with the Hamiltonian described by equation 2 and evolving the system to the Hamiltonian described by equation 3 in accordance with the evolution described by equation 1. Quantum processor 100 includes a plurality of interfaces 121-125 that are used to configure and control the state of quantum processor 100. Each of interfaces 121-125 may be realized by a respective inductive coupling structure, as illustrated, as part of a programming subsystem and/or an evolution subsystem. Such a programming subsystem and/or evolution subsystem may be separate from quantum processor 100, or it may be included locally (i.e., on-chip with quantum processor 100) as described in, for example, U.S. Pat. No. 7,876,248 and U.S. Pat. No. 8,035,540.

In the operation of quantum processor 100, interfaces 121 and 124 may each be used to couple a flux signal into a respective compound Josephson junction 131,132 of qubits 101 and 102, thereby realizing the Δᵢ terms in the system Hamiltonian. This coupling provides the off-diagonal σ^{x} terms of the Hamiltonian described by equation 2 and these flux signals are examples of “disordering signals.” Similarly, interfaces 122 and 123 may each be used to couple a flux signal into a respective qubit loop of qubits 101 and 102, thereby realizing the hᵢ terms in the system Hamiltonian. This coupling provides the diagonal σ^{z} terms of equation 3. Furthermore, interface 125 may be used to couple a flux signal into coupler 111, thereby realizing the Jᵢⱼ term(s) in the system Hamiltonian. This coupling provides the diagonal σᵢ^{z}σⱼ^{z} terms of equation 3. In FIG. 1, the contribution of each of interfaces 121-125 to the system Hamiltonian is indicated in boxes 121a-125a, respectively. Thus, throughout this specification and the appended claims, the terms “problem formulation” and “configuration of a number of programmable parameters” are used to refer to, for example, a specific assignment of hᵢ and Jᵢⱼ terms in the system Hamiltonian of a superconducting quantum processor via, for example, interfaces 121-125.

Throughout this specification and the appended claims, the term “quantum processor” is used to generally describe a collection of physical qubits (e.g., qubits 101 and 102) and couplers (e.g., coupler 111). The physical qubits 101 and 102 and the couplers 111 are referred to as the “programmable elements” of the quantum processor 100 and their corresponding parameters (e.g., the qubit hᵢ values and the coupler Jᵢⱼ values) are referred to as the “programmable parameters” of the quantum processor. In the context of a quantum processor, the term “programming subsystem” is used to generally describe the interfaces (e.g., “programming interfaces” 122, 123, and 125) used to apply the programmable parameters (e.g., the hᵢ and Jᵢⱼ terms) to the programmable elements of the quantum processor 100 and other associated control circuitry and/or instructions. As previously described, the programming interfaces of the programming subsystem may communicate with other subsystems which may be separate from the quantum processor or may be included locally on the processor. As described in more detail later, the programming subsystem may be configured to map candidate investments to the qubits of the quantum processor such that each candidate investment corresponds to at least one qubit in the quantum processor, and to map correlations between respective pairs of the candidate investments to the coupling devices of the quantum processor such that each correlation corresponds to at least one coupling device in the quantum processor. As illustrated in FIG. 1, programming interfaces 122, 123, and 125 of the programming subsystem of quantum processor 100 may be communicatively coupled, via communication conduits 151 and 152, to an investment portfolio optimization module 150. At least a respective portion of each of communication conduits 151 and 152 may be included “on-chip” (e.g., as superconducting lines or traces) in quantum processor 100. Exemplary characteristics of investment portfolio optimization module 150 are discussed in detail later. Similarly, in the context of a quantum processor, the term “evolution subsystem” is used to generally describe the interfaces (e.g., “evolution interfaces” 121 and 124) used to evolve the programmable elements of the quantum processor 100 and other associated control circuitry and/or instructions. For example, the evolution subsystem may include annealing signal lines and their corresponding interfaces (121, 124) to the qubits (101, 102).

Quantum processor 100 also includes readout devices 141 and 142, where readout device 141 is configured to read out the state of qubit 101 and readout device 142 is configured to read out the state of qubit 102. In the embodiment shown in FIG. 1, each of readout devices 141 and 142 comprises a respective DC-SQUID that is configured to inductively couple to the corresponding qubit (qubits 101 and 102, respectively). In the context of quantum processor 100, the term “readout subsystem” is used to generally describe the readout devices 141, 142 used to read out the final states of the qubits (e.g., qubits 101 and 102) in the quantum processor to produce a bit string. The readout subsystem may also include other elements, such as routing circuitry (e.g., latching elements, a shift register, or a multiplexer circuit) and/or may be arranged in alternative configurations (e.g., an XY-addressable array, an XYZ-addressable array, etc.). Qubit readout may also be performed using alternative circuits, such as that described in PCT Patent Publication 2012-064974.

While FIG. 1 illustrates only two physical qubits 101, 102, one coupler 111, and two readout devices 141, 142, a quantum processor (e.g., processor 100) may employ any number of qubits, couplers, and/or readout devices, including a larger number (e.g., hundreds, thousands or more) of qubits, couplers and/or readout devices. The application of the teachings herein to processors with a different (e.g., larger) number of computational components should be readily apparent to those of ordinary skill in the art.

The present systems and methods describe operating a quantum processor designed to perform adiabatic quantum computation and/or quantum annealing (e.g., quantum processor 100) to optimize an investment portfolio by determining an optimal subset of investments from the set of all candidate investments. The determination of an optimal portfolio of investments may be at least partially based on, for example, an analysis of the performance of individual candidate investments over a defined time period and/or correlations between pairs of candidate investments over a defined time period.

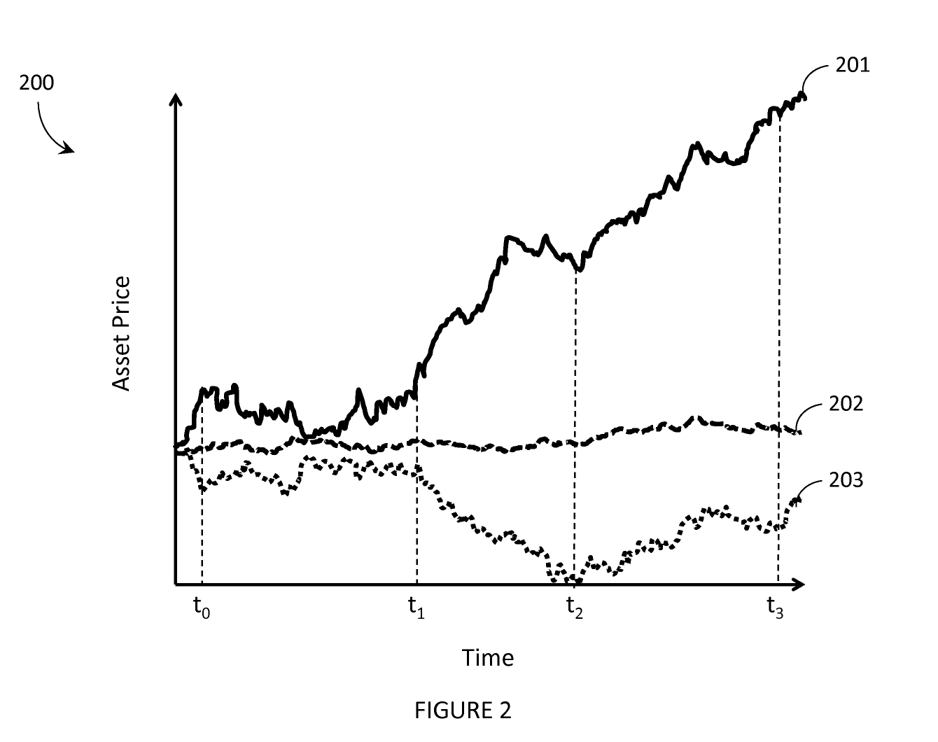

FIG. 2 is an illustrative graph 200 showing exemplary changes in the value (i.e., asset price) of three assets 201, 202, and 203 over time in accordance with the present systems and methods. Similar performance data for most candidate investments throughout global markets are available in computer-readable forms (e.g., digital information stored in non-volatile, computer-readable storage media). In accordance with the present systems and methods, a computer processor (e.g., a conventional computer processor such as a classical digital computer processor) may be operated to analyze similar performance data for any set of candidate investments. For example, the computer processor may be operated to evaluate a performance of each individual candidate investment within a defined time period.

Throughout this specification and the appended claims, the phrase “defined time period” is used to describe a period between two points in time, e.g., the time between a start point and an end point. The time period may be on the order of hours, days, weeks, months, years, or decades depending on the data available, the nature of the candidate investments being analyzed, and the criteria of the investment portfolio.

In graph 200 of FIG. 2, four exemplary points in time are defined: t₀, t₁, t₂, and t₃. Operating a computer processor to evaluate a performance of each candidate investment within a defined time period may include, for example, evaluating a change in a value of each individual candidate investment within the defined time period via the computer processor. In the exemplary graph 200 of FIG. 2, all three candidate investments 201, 202, and 203 have substantially the same performance within the time period from t₀ to t₁. Specifically, each of candidate investments 201, 202, and 203 shows approximately zero net change in value in the time period from t₀ to t₁. Evaluating the performance of investments 201, 202, and 203 in the time period from t₀ to t₁ assigns neutral performance to all three investments 201, 202, and 203. However, in the time period from t₁ to t₂, investment 201 significantly increases in value, investment 202 remains substantially constant in value, and investment 203 significantly decreases in value. Accordingly, evaluating the performance of investments 201, 202, and 203 in the time period from t₁ to t₂ assigns positive performance to investment 201, neutral performance to investment 202, and negative performance to investment 203.

A person of skill in the art will appreciate that the time period used to evaluate the performance of candidate investments can greatly influence the accuracy of the “performance” assigned to the investments. In general, it is typically instructive to include the most recent data in any time period used for the analyzing and evaluating purposes described herein. For example, in the case of the exemplary data shown in graph 200 of FIG. 2, a time period ending in t₃ (e.g., the period from t₂ to t₃, or the period from t₁ to t₃, or the period from t₀ to t₃) may best represent the current expected performance of candidate investments 201, 202, and 203. Evaluating the performance of investments 201, 202, and 203 in the time period from t₂ to t₃, for example, assigns a first positive performance to investment 201, a substantially neutral performance to investment 202, and a second positive performance to investment 203. As the increase in value of investment 201 over the time period from t₂ to t₃ exceeds the increase in value of investment 203, the first positive performance of investment 201 is greater in magnitude than the second positive performance of investment 203.

Throughout this specification and the appended claims, the term “positive performance” is used to describe the performance of an investment (i.e., a candidate investment) that increases in value over a defined time period, while the term “negative performance” is used to describe the performance of an investment (i.e., a candidate investment) that decreases in value over a defined time period.

In accordance with the present systems and methods, a computer processor (e.g., a conventional computer processor such as a classical digital computer processor) may be operated to analyze correlation data for any set of candidate investments within a defined time period. For example, the computer processor may be operated to evaluate a correlation between each respective pair of the candidate investments within the defined time period.

Operating a computer processor to evaluate a correlation between each respective pair of the candidate investments within a defined time period may include, for example, comparing the respective changes in value of each respective pair of candidate investments within the defined time period via the computer processor. In the time period from t₁ to t₂ of exemplary graph 200, the respective values of investments 201 and 203 move in opposite directions while the value of investment 202 remains substantially constant. Accordingly, during the time period from t₁ to t₂, evaluating a correlation between each respective pair of candidate investments 201, 202, and 203 may assign a negative correlation to the pairing of investments 201 and 203, no correlation to the pairing of investments 201 and 202, and no correlation to the pairing of investments 202 and 203. On the other hand, during the time period from t₂ to t₃, 201 and 203 both increase in value. Thus, during the time period from t₂ to t₃, investments 201 and 203 appear to be positively correlated.

Throughout this specification and the appended claims, the term “positive correlation” is used to describe the relationship between a pair of investments (i.e., candidate investments) that both change in value in the same direction over a defined time period, while the term “negative correlation” is used to describe the relationship between a pair of investments (i.e., candidate investments) that both change in value in opposite directions over the defined time period.

The example shown in FIG. 2 illustrates how performance features and correlation features may be assessed for dynamic assets, such as stocks. However, the present systems and methods encompass all forms of candidate investments and a person of skill in the art of financial analysis will appreciate that the nature of performance features and correlation features may depend on the nature of the specific candidate investment being analyzed. As another example, a candidate investment may include a fixed-income security such as a bond with a fixed interest rate. In this case, a performance feature may assess, for example, the fixed interest rate of the bond relative to the federal interest rate and a correlation feature may assess, for example, the security rating of the bond relative to the volatility of the federal interest rate.

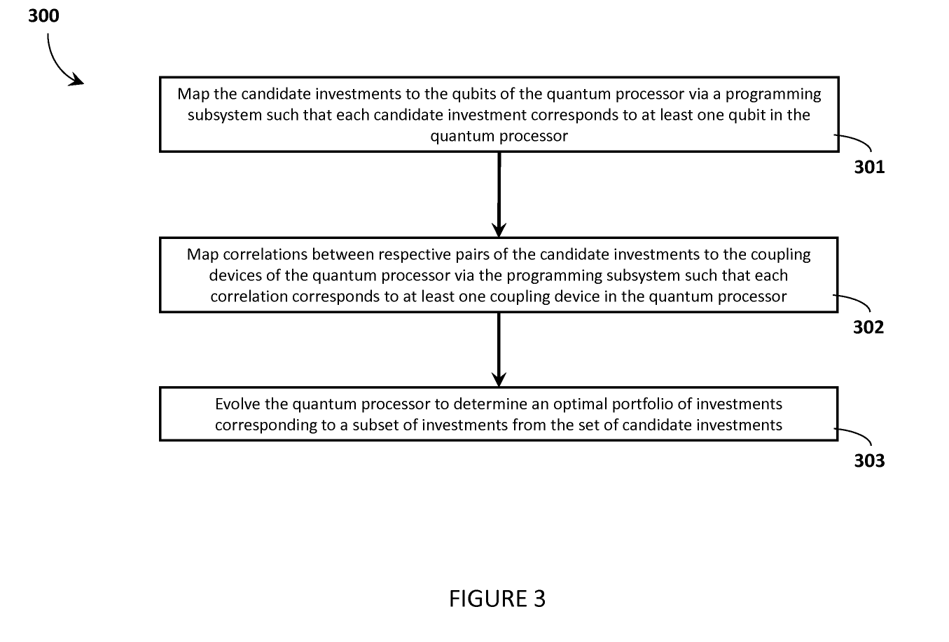

FIG. 3 is a flow-diagram showing a method 300 of operating a quantum processor to optimize an investment portfolio in accordance with the present systems and methods. Method 300 includes three acts 301-303, though those of skill in the art will appreciate that in alternative embodiments certain acts may be omitted and/or additional acts may be added. Those of skill in the art will appreciate that the illustrated order of the acts is shown for exemplary purposes only and may change in alternative embodiments. At 301, the candidate investments are mapped to the qubits (e.g., qubits 101 and 102) of the quantum processor via a programming subsystem (e.g., programming interfaces 122, 123, and 125) such that each candidate investment corresponds to at least one qubit in the quantum processor. Any given candidate investment may be mapped to two or more qubits in the quantum processor at the same time if such facilitates programming of the quantum processor and/or enables specific pair-wise couplings between qubits (i.e., investments) that would not otherwise be available. See, e.g., U.S. Pat. No. 7,984,012 and U.S. Pat. No. 8,244,662, each of which is incorporated by reference herein in its entirety, for more detail on mapping variables to qubits. At 302, the correlations between respective pairs of the candidate investments are mapped to the coupling devices (e.g., coupling device 111) of the quantum processor via the programming subsystem such that each correlation corresponds to at least one coupling device in the quantum processor. At 303, the quantum processor is evolved to determine an optimal portfolio of investments corresponding to a subset of investments from the set of candidate investments. Evolving the quantum processor may be done via an evolution subsystem (e.g., evolution interfaces 121 and 124) and may comprise, for example, performing adiabatic quantum computation and/or quantum annealing to determine a minimum energy configuration of the quantum processor that satisfies the mappings from acts 301 and 302.

Acts 301 and 302 (e.g., mapping the candidate investments to the qubits of the quantum processor and the correlations between investments to the coupling devices of the quantum processor) may be viewed as effectively reducing the optimization problem to a graphical representation. Evolving the quantum processor may then comprise, for example, determining a maximum independent set or a maximum clique of the graphical representation of the problem in a manner similar to those described in U.S. Pat. No. 7,870,087, U.S. Pat. No. 8,032,474, U.S. Pat. No. 8,073,808, and US Patent Publication 2012-0045136, each of which is incorporated herein by reference in its entirety.

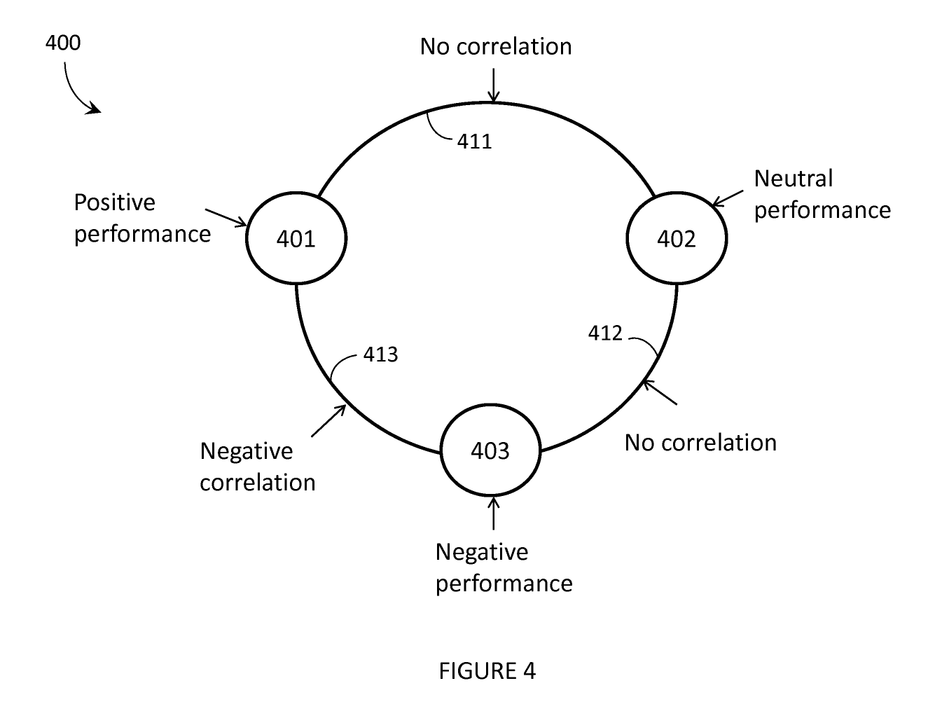

FIG. 4 is an illustrative diagram providing a graphical representation 400 of the analysis (e.g., performed by a digital computer system) of investments 201, 202, and 203 over the time period from t₀ to t₃ (from FIG. 2) in accordance with the present systems and methods. In FIG. 4, node 401 corresponds to investment 201, node 402 corresponds to investment 202, and node 403 corresponds to investment 203. Similarly, edge 411 corresponds to the correlation between investments 201 and 202, edge 412 corresponds to the correlation between investments 202 and 203, and edge 413 corresponds to the correlation between investments 203 and 201. In accordance with the present systems and methods, graphical representation 400 may readily be mapped to a quantum processor designed to perform adiabatic quantum computation and/or quantum annealing. For example, node 401 may be mapped to a first qubit (e.g., qubit 101), node 402 may be mapped to a second qubit (e.g., qubit 102), and edge 411 may be mapped to a first coupling device (e.g., coupling device 111) operable to provide communicative coupling between the first qubit and the second qubit. A person of skill in the art will appreciate how any number of nodes and edges corresponding to any number of investments and correlations may similarly be mapped to any quantum processor comprising sufficient qubits and coupling devices.

In FIG. 4, the evaluations of investment performance and pair-wise correlations are illustrated. For example, since the value of investment 201 shows a net increase in the time period from t₀ to t₃, node 401 is indicated as having positive performance. Similarly, investment 202 shows substantially no net change over the period from t₀ to t₃, so node 402 is indicated as having neutral performance, and investment 203 shows a net decrease in the time period from t₀ to t₃, so node 403 is indicated as having negative performance. In accordance with the present systems and methods, the performance of any particular investment (or node in a graphical representation) may be programmed into the quantum processor via the hᵢ term assigned to the particular qubit (or qubits) that represents (or represent) that particular investment. For example, with investment 201 corresponding to node 401 mapped to qubit 101 in quantum processor 100, the positive performance of investment 201 may be programmed into quantum processor 100 via programming interface 122 of the programming subsystem by assigning an hᵢ term to qubit 101 that is representative of the positive performance of investment 201 (e.g., a positive or a negative hᵢ term, depending on the problem formulation as would be understood by a person of skill in the art). Similarly, node 402 having neutral performance may be mapped to a qubit and programmed with an hᵢ term indicative of neutral performance (e.g., an hᵢ term of zero) and node 403 having negative performance may be mapped to a qubit and programmed with an hᵢ term indicative of negative performance (e.g., an hᵢ term that is opposite in sign from that corresponding to node 401). Furthermore, any particular correlation between investments may be programmed into the quantum processor via the Jᵢⱼ term assigned to the particular coupling device that represents that particular correlation. For example, with the correlation between investments 201 and 202 corresponding to edge 411 mapped to coupling device 111 in quantum processor 100, the lack of a correlation between investments 201 and 202 may be programmed into quantum processor 100 via programming interface 125 of the programming subsystem by assigning a Jᵢⱼ term to coupling device 111 that is representative of no correlation between investments 201 and 202 (e.g., a Jᵢⱼ term of zero). Similarly, a coupling device that represents edge 412 (i.e., the correlation between nodes 402 and 403) may be programmed with a Jᵢⱼ term that is representative of no correlation and a coupling device that represents edge 413 (i.e., the correlation between nodes 403 and 401) may be programmed with a Jᵢⱼ term that is representative of a negative correlation (e.g., a positive of a negative Jᵢⱼ term, depending on the problem formulation).

The above description details an example of how a quantum processor may be operated to optimize an investment portfolio. However, as described previously, the programming of the quantum processor takes into account data analysis performed, for example, by a digital computer system. Thus, the systems and methods of operating a quantum processor to optimize an investment portfolio may incorporate digital computer systems and methods.

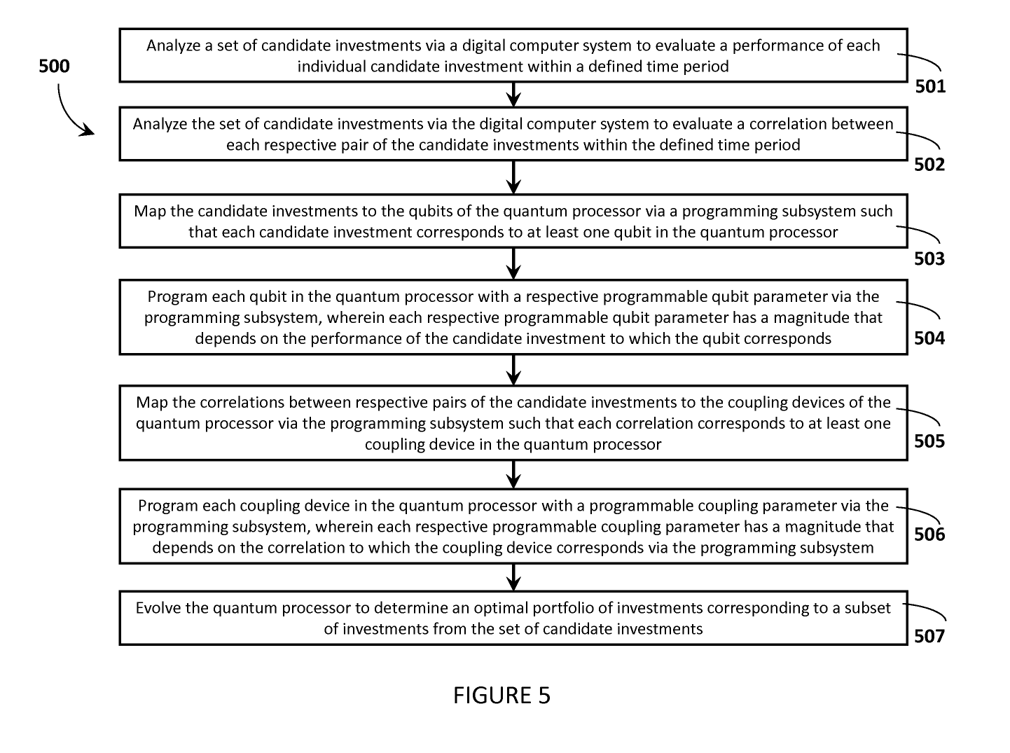

FIG. 5 is a flow-diagram showing a method 500 of operating a digital computer system and a quantum processor to optimize an investment portfolio in accordance with the present systems and methods. Method 500 includes seven acts 501-507, though those of skill in the art will appreciate that in alternative embodiments certain acts may be omitted and/or additional acts may be added. Those of skill in the art will appreciate that the illustrated order of the acts is shown for exemplary purposes only and may change in alternative embodiments. At 501, a set of candidate investments is analyzed via a digital computer system to evaluate a performance of each individual candidate investment within a defined time period. The digital computer system may comprise a conventional computer system as described in more detail later. Analyzing the set of candidate investments via the digital computer system to evaluate the performance of each individual candidate investment within a defined time period may include, for example, generating a first subset of the candidate investments having positive performance within the defined time period and a second subset of the candidate investments having negative performance within the defined time period. At 502, the set of candidate investments is analyzed via the digital computer system to evaluate a correlation between each respective pair of the candidate investments within the defined time period. Analyzing the set of candidate investments via the digital computer system to evaluate the correlation between each respective pair of the candidate investments within the defined time period may include, for example, generating a first subset of correlations between pairs of the candidate investments that are positively correlated within the defined time period and a second subset of correlations between pairs of the candidate investments that are negatively correlated within the defined time period. As described in more detail later, either or each of acts 501 and 502 may be executed via a dedicated software module stored in a non-transitory computer-readable medium of a digital computer system, such as an investment portfolio optimization module. At 503, the candidate investments are mapped to the qubits of the quantum processor via a programming subsystem such that each candidate investment corresponds to at least one qubit in the quantum processor. The programming subsystem may receive programming instructions from the investment portfolio optimization module. At 504, each qubit in the quantum processor is programmed with a respective programmable qubit parameter via the programming subsystem, wherein each respective programmable qubit parameter has a sign and a magnitude that depend on the performance of the candidate investment to which the qubit corresponds. Programming each qubit in the quantum processor may include, for example, programming each qubit that corresponds to a candidate investment from the first subset of candidate investments having positive performance with a respective programmable qubit parameter having a positive magnitude via the programming subsystem and/or programming each qubit that corresponds to a candidate investment from the second subset of candidate investments having negative performance with a respective programmable qubit parameter having a negative magnitude via the programming subsystem. At 505, the correlations between respective pairs of the candidate investments are mapped to the coupling devices of the quantum processor via the programming subsystem such that each correlation corresponds to at least one coupling device in the quantum processor. Again, the programming subsystem may receive programming instructions from the investment portfolio optimization module. At 506, each coupling device in the quantum processor is programmed with a programmable coupling parameter via the programming subsystem, wherein each respective programmable coupling parameter has a sign and a magnitude that depend on the correlation to which the coupling device corresponds via the programming subsystem. Programming each coupling device in the quantum processor may include, for example, programming each coupling device that corresponds to a correlation from the first subset of correlations between pairs of candidate investments that are positively correlated with a respective programmable coupling parameter having a positive magnitude via the programming subsystem and/or programming each coupling device that corresponds to a correlation from the second subset of correlations between pairs of candidate investments that are negatively correlated with a respective programmable coupling parameter having a negative magnitude via the programming subsystem. At 507, the quantum processor is evolved to determine an optimal portfolio of investments corresponding to a subset of investments from the set of candidate investments. The evolution may be done via an evolution subsystem and may comprise at least one of adiabatic quantum computation and/or quantum annealing to determine a minimum energy configuration of the qubit states in the quantum processor, subject to the programmable qubit parameters and the programmable coupling parameters, where the minimum energy configuration may correspond to a selection of the candidate investments that provide a positive average expected performance and/or are predominately anti-correlated or uncorrelated.

In accordance with the present systems and methods, the optimal portfolio of investments may include, for example, predominately investments from the first subset of candidate investments having positive performance and/or, for example, predominately pairs of investments that correspond to correlations from the second subset of correlations between pairs of candidate investments that are negatively correlated (or uncorrelated).

Once an optimal portfolio of investments has been determined, it may be advantageous to evaluate how to allocate the portfolio funds between the various selected investments. In accordance with the present systems and methods, a quantum processor and/or a digital computer system may be operated for this purpose.

In some instances, it may be advantageous to evaluate the allocation of the total portfolio funds between investments as a factor in determining which investments to select. For example, rather than solely using each node in a graphical representation of the problem (and correspondingly each qubit in the quantum processor) to represent a single investment in its entirety, nodes/qubits may also be used to represent relative percentages of investments with respect to the total portfolio. For example, a first qubit may be programmed to represent “X % of portfolio funds invested in investment 201” while a second qubit may be programmed to represent “Y % of portfolio funds invested in investment 201.” In such instances, it is not necessary for a coupling device to exist between the first qubit and the second qubit, as such a correlation would be meaningless.

Although various aspects of the present systems and methods are described as involving “a digital computer system” and successive acts may be described as performed via “the digital computer system,” a person of skill in the art will appreciate that the present systems and methods may employ any number of digital computers (i.e., one or more digital computers) and successive acts (i.e., digital processing tasks) in any method may be performed on the same digital computer or on different digital computers (either in series or in parallel) that are in communication with one another, for example using conventional microprocessors.

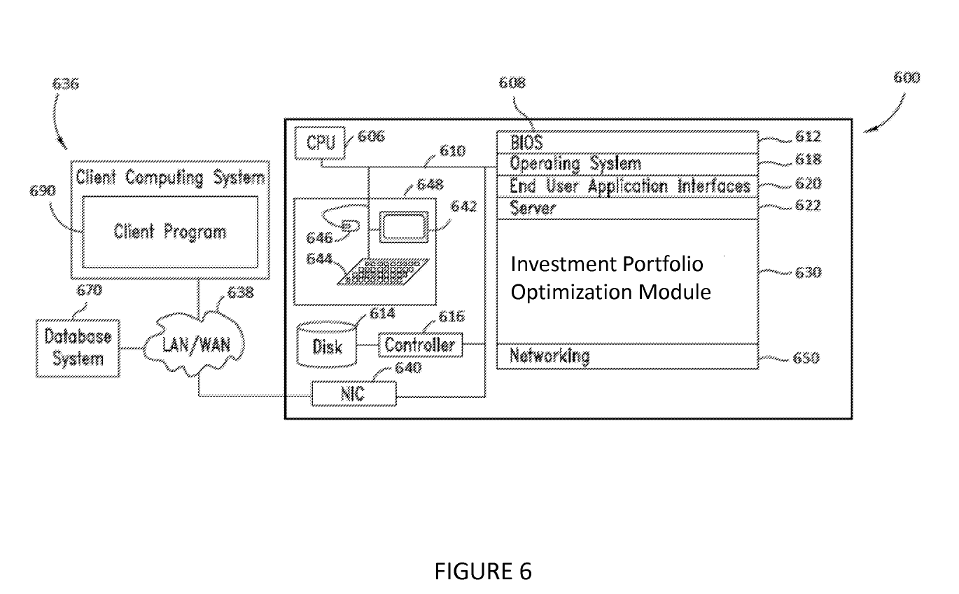

FIG. 6 illustrates an exemplary digital computer system 600 including a digital computer processor 606 that may be used to perform classical digital processing tasks described in the present systems and methods. Those skilled in the relevant art will appreciate that the present systems and methods can be practiced with other digital computer configurations, including hand-held devices, multiprocessor systems, microprocessor-based or programmable consumer electronics, personal computers (“PCs”), network PCs, mini-computers, mainframe computers, and the like. The present systems and methods can also be practiced in distributed computing environments, where tasks or modules are performed by remote processing devices, which are linked through a communications network. In a distributed computing environment, program modules may be located in both local and remote memory storage devices.

Digital computer system 600 may include at least one processing unit 606 (i.e., digital computer processor), at least one system memory 608, and at least one system bus 610 that couples various system components, including system memory 608 to digital computer processor 606. Digital computer system 600 will at times be referred to in the singular herein, but this is not intended to limit the application to a single digital computer system 600. For example, there may be more than one digital computer system 600 or other classical computing device involved throughout the present systems and methods.

Digital computer processor 606 may be any logic processing unit, such as one or more central processing units (“CPUs”), digital signal processors (“DSPs”), application-specific integrated circuits (“ASICs”), etc. Unless described otherwise, the construction and operation of the various blocks shown in FIG. 6 are of conventional design. As a result, such blocks need not be described in further detail herein, as they will be understood by those skilled in the relevant art.

System bus 610 can employ any known bus structures or architectures, including a memory bus with a memory controller, a peripheral bus, and a local bus. System memory 608 may include non-transitory memory and/or non-volatile memory such as read-only memory (“ROM”) and/or volatile memory such as random access memory (“RAM”) (not shown). A basic input/output system (“BIOS”) 612, which can form part of the ROM, contains basic routines that help transfer information between elements within digital computer system 600, such as during startup.

Digital computer system 600 may also include other non-volatile memory 614. Non-volatile memory 614 may take a variety of forms, including: a hard disk drive for reading from and writing to a hard disk, an optical disk drive for reading from and writing to removable optical disks, and/or a magnetic disk drive for reading from and writing to magnetic disks. The optical disk can be a CD-ROM or DVD, while the magnetic disk can be a magnetic floppy disk or diskette. Non-volatile memory 614 may communicate with digital computer processor 606 via system bus 610 and may include appropriate interfaces or controllers 616 coupled between non-volatile memory 614 and system bus 610. Non-volatile memory 614 may serve as long-term storage for computer-readable instructions, data structures, program modules and other data for digital computer system 600. Although digital computer system 600 has been described as employing hard disks, optical disks and/or magnetic disks, those skilled in the relevant art will appreciate that other types of non-volatile computer-readable media may be employed, such a magnetic cassettes, flash memory cards, Bernoulli cartridges, Flash, ROMs, smart cards, etc.

Various program modules, application programs and/or data can be stored in system memory 608. For example, system memory 608 may store an operating system 618, end user application interfaces 620 and server applications 622. In accordance with the present systems and methods, system memory 608 may store an investment portfolio optimization module 630 that stores and executes (via digital processor 606) instructions for interacting with a quantum processor to optimize an investment portfolio as described herein. Investment portfolio optimization module 630 may interface with the programming subsystem of a quantum processor as illustrated in FIG. 1.

System memory 608 may also include one or more networking applications 650, for example, a Web server application and/or Web client or browser application for permitting digital computer system 600 to exchange data with sources via the Internet, corporate Intranets, or other networks, as well as with other server applications executing on server computers. Networking application 650 in the depicted embodiment may be markup language based, such as hypertext markup language (“HTML”), extensible hypertext markup language (“XHTML”), extensible markup language (“XML”) or wireless markup language (“WML”), and may operate with markup languages that use syntactically delimited characters added to the data of a document to represent the structure of the document. A number of Web server applications and Web client or browser applications are commercially available, such as those available from Mozilla and Microsoft.

While shown in FIG. 6 as being stored in system memory 608, operating system 618 and various applications/modules 620, 622, 630, 650 and other data can also be stored in nonvolatile memory 614.

Digital computer system 600 can operate in a networking environment using logical connections to at least one client computer system 636 and at least one database system 670. These logical connections may be formed using any means of digital communication, for example, through a network 638, such as a local area network (“LAN”) or a wide area network (“WAN”) including, for example, the Internet. The networking environment may include wired or wireless enterprise-wide computer networks, intranets, extranets, and/or the Internet. Other embodiments may include other types of communication networks such as telecommunications networks, cellular networks, paging networks, and other mobile networks. The information sent or received via the logical connections may or may not be encrypted. When used in a LAN networking environment, digital computer system 600 may be connected to the LAN through an adapter or network interface card (“NIC”) 640 (communicatively linked to system bus 610). When used in a WAN networking environment, digital computer system 600 may include an interface and modem (not shown), or a device such as NIC 640, for establishing communications over the WAN. Non-networked communications may additionally, or alternatively be employed.

In a networked environment, program modules, application programs, data, or portions thereof can be stored outside of digital computer system 600. Those skilled in the relevant art will recognize that the logical connections shown in FIG. 6 are only some examples of establishing communications between computers, and other connections may also be used.

While digital computer system 600 may generally operate automatically, an end user application interface 620 may also be provided such that an operator can interact with digital computer system 600 through different user interfaces 648, including output devices, such as a monitor 642, and input devices, such as a keyboard 644 and a pointing device (e.g., mouse 646). Monitor 642 may be coupled to system bus 610 via a video interface, such as a video adapter (not shown). Digital computer system 600 can also include other output devices, such as speakers, printers, etc. Other input devices can also be used, including a microphone, joystick, scanner, etc. These input devices may be coupled to digital computer processor 606 via a serial port interface that couples to system bus 610, a parallel port, a game port, a wireless interface, a universal serial bus (“USB”) interface, or via other interfaces.

NIC 640 may include appropriate hardware and/or software for interfacing with the elements of a quantum processor (not shown). In other embodiments, different hardware may be used to facilitate communications between digital computer system 600 and a quantum processor. For example, digital computer system 600 may communicate with a quantum processor via a direct electrical connection (e.g., via Universal Serial Bus, Firewire, or the like), a wireless connection (e.g., via a Wi-Fi® network), or an Internet connection.

Client computer system 636 may comprise any of a variety of computing devices communicatively coupled to digital computer system 600, and may include a client program 690 configured to properly format and send problems directly or indirectly to server application 622. Once digital computer system 600 has determined a solution, server application 622 may be configured to send information indicative of this solution back to client program 690.

As previously described, mapping candidate investments to the qubits of a quantum processor and mapping correlations between investments to the coupling devices of the quantum processor may be viewed as effectively reducing the optimization problem to a graphical representation. U.S. Pat. No. 7,984,012 and U.S. Pat. No. 8,244,662, each of which is incorporated by reference herein in its entirety, provide more detail on embedding a graphical representation of a problem into a quantum processor. However, in some instances it may be preferable to operate a quantum processor to optimize an investment portfolio without mapping a graphical representation of the problem to the quantum processor. For example, in some instances it may be preferable to define an objective function that encodes the performance and correlation data for a set of candidate investments. The techniques described in PCT Patent Application Serial No. PCT/US2012/045843, which is incorporated herein by reference in its entirety, may then be employed to minimize such an objective function and determine an optimal portfolio of investments from the set of candidate investments.

Depending on the availability of data and the availability of qubits in the quantum processor, factors that may correlate with candidate investments but which are not candidate investments themselves may also be mapped to the quantum processor. For example, events and/or social issues may be mapped to qubits in the quantum processor and coupled to qubits that represent candidate investments. The coupling between a qubit that represents an event or social issue and a qubit that represents a candidate investment may be programmed to represent a correlation between the event or social issue and the candidate investment. For example, an election outcome, a flood, a war, or the like (i.e., a “scenario”) may be mapped to a qubit in the quantum processor, where the corresponding programmable qubit parameter (i.e., the hᵢ term of the qubit) may represent, for example, the probability of the scenario being represented. An analysis (via, e.g., a digital computer system) may show if the scenario comes into effect, a candidate investment may increase (positive correlation) or decrease (negative correlation) in value. Accordingly, a coupling device providing communicative coupling between the qubit that represents the scenario and the qubit that represents the candidate investment may be programmed with programmable coupling parameter (i.e., the Jᵢⱼ term of the coupling device) that represents the correlation between the scenario and the candidate investment. In this way, alternative optimal investment portfolios may be determined for situations where given scenarios do or do not come into effect.

Many techniques have been explored for optimizing investment portfolios. In the art, such techniques typically make use of continuous variables, at least in part because employing only discrete variables (i.e., discrete optimization) is known to be computationally difficult. However, the quantum processors described in the present systems and methods are particularly well-suited for discrete optimization where the states of binary qubits represent the states of binary (i.e., discrete) variables. The present systems and methods effectively provide an L0-norm regularization of the optimization of an investment portfolio and the discretization of the problem formulation has the inherent benefit of reducing the overall transaction costs in the optimized investment portfolio. For example, the present systems and methods teach mapping performance features of candidate investments to qubits in a quantum processor, mapping correlation features between candidate investments to coupling devices in a quantum processor, and evolving the quantum processor to determine which candidate investments should be included in an “optimized” investment portfolio. After the quantum processor is evolved, each qubit (i.e., each discrete variable) returns either a 0 or a 1, where a 0 may indicate that the corresponding candidate investment should not be included in the optimized portfolio and a 1 may indicate that the corresponding candidate investment should be included in the optimized portfolio (or vice versa, depending on the problem formulation). This simple prescription of 1=“Buy”, 0=“Don't Buy” simplifies the transaction structure (compared to the more typically optimizations done over continuous variables) and, as a result, can reduce overall transaction costs.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other methods of quantum computation, not necessarily the exemplary methods for quantum computation generally described above.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a digital computer system and a quantum processor to optimize a portfolio of investments, wherein the quantum processor comprises a number of qubits and a number of coupling devices operable to provide communicative coupling between respective pairs of the qubits, the method comprising:
analyzing a set of candidate investments via the digital computer system to evaluate a performance of each individual candidate investment within a defined time period;
analyzing the set of candidate investments via the digital computer system to evaluate a correlation between each respective pair of the candidate investments within the defined time period;
mapping the candidate investments to the qubits of the quantum processor via a programming subsystem such that each candidate investment corresponds to at least one qubit in the quantum processor;
programming each qubit in the quantum processor with a respective programmable qubit parameter via the programming subsystem, wherein each respective programmable qubit parameter has a sign and a magnitude that depend on the performance of the candidate investment to which the qubit corresponds;
mapping the correlations between respective pairs of the candidate investments to the coupling devices of the quantum processor via the programming subsystem such that each correlation corresponds to at least one coupling device in the quantum processor;
programming each coupling device in the quantum processor with a programmable coupling parameter via the programming subsystem, wherein each respective programmable coupling parameter has a sign and a magnitude that depend on the correlation to which the coupling device corresponds; and
evolving the quantum processor via an evolution subsystem to determine an optimal portfolio of investments corresponding to a subset of investments from the set of candidate investments.

2. The method of claim 1 wherein evolving the quantum processor via an evolution subsystem comprises performing at least one of adiabatic quantum computation and quantum annealing via the quantum processor.

3. The method of claim 1 wherein the quantum processor includes a superconducting quantum processor comprising superconducting qubits and superconducting coupling devices.

4. The method of claim 1 wherein each respective programmable qubit parameter corresponds to a respective hᵢ term in a Hamiltonian of the quantum processor.

5. The method of claim 1 wherein each respective programmable coupling parameter corresponds to a respective Jᵢⱼ term in a Hamiltonian of the quantum processor.

6. The method of claim 1 wherein the set of candidate investments includes at least one investment selected from the group consisting of: a stock, a bond, a stock index, an equity, a currency, an asset and a commodity.

7. The method of claim 1 wherein the defined time period is selected from the group consisting of: a number of hours, a number of days, a number of weeks, a number of months, a number of years, and a number of decades.

8. The method of claim 1 wherein analyzing a set of candidate investments via a digital computer system to evaluate a performance of each individual candidate investment within a defined time period includes generating a first subset of the candidate investments having positive performance within the defined time period and a second subset of the candidate investments having negative performance within the defined time period via the digital computer system.

9. The method of claim 8 wherein programming each qubit in the quantum processor with a respective programmable qubit parameter via the programming subsystem includes programming each qubit that corresponds to a candidate investment from the first subset of candidate investments having positive performance with a respective programmable qubit parameter having a positive magnitude via the programming subsystem.

10. The method of claim 9 wherein programming each qubit in the quantum processor with a respective programmable qubit parameter via the programming subsystem includes programming each qubit that corresponds to a candidate investment from the second subset of candidate investments having negative performance with a respective programmable qubit parameter having a negative magnitude via the programming subsystem.

11. The method of claim 8 wherein the optimal portfolio of investments includes predominately investments from the first subset of candidate investments having positive performance.

12. The method of claim 1 wherein analyzing a set of candidate investments via a digital computer system to evaluate a performance of each individual candidate investment within a defined time period includes evaluating a change in a value of each individual candidate investment within the defined time period via the digital computer system.

13. The method of claim 1 wherein analyzing the set of candidate investments via the digital computer system to evaluate a correlation between each respective pair of the candidate investments within the defined time period includes generating a first subset of correlations between pairs of the candidate investments that are positively correlated within the defined time period and a second subset of correlations between pairs of the candidate investments that are negatively correlated within the defined time period via the digital computer system.

14. The method of claim 13 wherein programming each coupling device in the quantum processor with a respective programmable coupling parameter via the programming subsystem includes programming each coupling device that corresponds to a correlation from the first subset of correlations between pairs of candidate investments that are positively correlated with a respective programmable coupling parameter having a positive magnitude via the programming subsystem.

15. The method of claim 14 wherein programming each coupling device in the quantum processor with a respective programmable coupling parameter via the programming subsystem includes programming each coupling device that corresponds to a correlation from the second subset of correlations between pairs of candidate investments that are negatively correlated with a respective programmable coupling parameter having a negative magnitude via the programming subsystem.

16. The method of claim 13 wherein the optimal portfolio of investments includes predominately pairs of investments that correspond to correlations from the second subset of correlations between pairs of candidate investments that are negatively correlated.

17. The method of claim 1 wherein analyzing a set of candidate investments via a digital computer system to evaluate a correlation between each respective pair of the candidate investments within the defined time period includes evaluating a change in a value of each individual candidate investment within the defined time period via the digital computer system and comparing the respective changes in the value of each respective pair of candidate investments via the digital computer system.

18. The method of claim 1 wherein the digital computer system includes a non-transitory computer-readable memory that stores an investment portfolio optimization module, and wherein analyzing a set of candidate investments via the digital computer system to evaluate a performance of each individual candidate investment within a defined time period includes analyzing the set of candidate investments via the investment portfolio optimization module and analyzing the set of candidate investments via the digital computer system to evaluate a correlation between each respective pair of the candidate investments within the defined time period includes analyzing the set of candidate investments via the investment portfolio optimization module.

19. A method of operating a quantum processor to optimize a portfolio of investments, wherein the quantum processor comprises a number of qubits and a number of coupling devices operable to provide communicative coupling between respective pairs of the qubits and the portfolio of investments comprises a subset of investments from a set of candidate investments, the method comprising:
mapping the candidate investments to the qubits of the quantum processor via a programming subsystem such that each candidate investment in the set of candidate investments corresponds to at least one qubit in the quantum processor;
mapping correlations between respective pairs of the candidate investments to the coupling devices of the quantum processor via the programming subsystem such that each correlation corresponds to at least one coupling device in the quantum processor; and
evolving the quantum processor via an evolution subsystem to determine an optimal portfolio of investments corresponding to a subset of investments from the set of candidate investments.

20. The method of claim 19 wherein evolving the quantum processor via an evolution subsystem comprises performing at least one of adiabatic quantum computation and quantum annealing via the quantum processor.

21. The method of claim 19 wherein the quantum processor includes a superconducting quantum processor comprising superconducting qubits and superconducting coupling devices.

22. The method of claim 19, further comprising:
programming each qubit in the quantum processor with a respective programmable qubit parameter via the programming subsystem, wherein each respective programmable qubit parameter has a sign and a magnitude that depend on the performance of the candidate investment to which the qubit corresponds, and wherein each respective programmable qubit parameter corresponds to a respective hᵢ term in a Hamiltonian of the quantum processor.

23. The method of claim 19, further comprising:
programming each coupling device in the quantum processor with a programmable coupling parameter via the programming subsystem, wherein each respective programmable coupling parameter has a sign and a magnitude that depend on the correlation to which the coupling device corresponds, and wherein each respective programmable coupling parameter corresponds to a respective Jᵢⱼ term in a Hamiltonian of the quantum processor.

24. The method of claim 19 wherein the set of candidate investments includes at least one investment selected from the group consisting of: a stock, a bond, a stock index, an equity, a currency, an asset and a commodity.

25. The method of claim 19 wherein the defined time period is selected from the group consisting of: a number of hours, a number of days, a number of weeks, a number of months, a number of years, and a number of decades.
